(19) United States
(12) Patent Application Publication
(10) Pub. No.: US 2020/0387630 A1
(43) Pub. Date: Dec. 10, 2020

(54) RISK ASSESSMENT ENGINE

(71) Applicant: TrustArc Inc, San Francisco, CA (US)

(72) Inventors: Hilary M. Wandall, Center Valley, PA (US); Christopher P. Casey, Berkeley, CA (US); Joseph Jacob Green, San Francisco, CA (US); Neng Gu, San Jose, CA (US); Binh P. Le, San Jose, CA (US); Joanne Furtsch, Sacramento, CA (US); Maciej Switalski, Peachland (CA)

(21) Appl. No.: 16/894,836

(22) Filed: Jun. 7, 2020

Related U.S. Application Data
(60) Provisional application No. 62/916,205, filed on Oct. 16, 2019.
(60) Provisional application No. 62/936,607, filed on Nov. 18, 2019.
(60) Provisional application No. 62/858,979, filed on Jun. 8, 2019.
(60) Provisional application No. 62/858,980, filed on Jun. 8, 2019.

(51) Int. Cl. G06F 21/62; G06Q 10/06; G06Q 50/26; G06Q 10/10; G06Q 30/00; H04L 12/851

(52) U.S. Cl. CPC G06F 21/6245; G06Q 10/0635; H04L 47/2483; G06Q 10/10; G06Q 30/0185; G06Q 50/265

(57) ABSTRACT

A system, method and computer program product for assessing risk of a process through a set of entities identified as utilizing personal data needing protection from misuse and wrongful disclosure comprising mapping the identified process including identifying a purpose of the identified process and a sensitivity of that purpose; identifying data elements including the utilized personal data and including a volume and sensitivity of those identified data elements; identifying data types including the utilized personal data and including a volume and sensitivity of those identified data types; identifying data subjects about whom data is involved in the process including a volume and sensitivity of those identified data subjects; and identifying the set of entities involved in the process and their locations; and identifying data flows among the set of entities involved in the process; and applying a set of rules against the mapped process to provide a risk assessment of the mapped process based on the risk sensitivity of the process purpose, sensitivity and volume of each data element, data type, and data subject, risk related to the entity locations and data flows among the entity locations.

### PRIORITY CLAIM

This application claims priority to U.S. Provisional Application No. 62/916,205, filed Oct. 16, 2019, entitled “RISK ASSESSMENT ENGINE”, to U.S. Provisional Application No. 62/936,607, filed Nov. 18, 2019, entitled “RISK MANAGEMENT OF PROCESSES UTILIZING PERSONAL DATA”, to U.S. Provisional Application No. 62/858,979, filed Jun. 8, 2019, entitled “DYNAMICALLY ADAPTABLE RULES AND COMMUNICATION SYSTEM TO MANAGE PROCESS CONTROL-BASED USE CASES”, and to U.S. Provisional Application No. 62/858,980, filed Jun. 8, 2019, entitled “DYNAMICALLY ADAPTABLE RULES AND COMMUNICATION SYSTEM FOR MANAGING PROCESS CONTROLS”, the disclosures of which are incorporated in their entirety herein by reference.

### BACKGROUND

### Technical Field

The present invention relates generally to a risk assessment engine, and more specifically to a computer-implemented method for a risk assessment of processes involving personal data, including sensitive data and other privacy data.

### Description of Related Art

With the advent of the internet and mass communications of data worldwide, a host of data management issues have arisen. Many entities are gaining and sharing access to an increasingly large variety of data types, including personal data, much of which may be sensitive. In addition, this is occurring among a proliferation of data privacy, security policies, export controls, etc. For example, various governments, standard bodies and other entities have instituted a large variety of laws, regulations or rules addressing and enforcing certain data management policies (e.g., the European Union (EU) General Data Protection Regulation (GDPR)). As a result, it is becoming substantially more difficult to manage the use and sharing of data types while complying with a multitude of laws, regulations and rules.

Whether certain laws regulations or rules apply to an entity's process controls depends on a variety of conditions including the type of entity, where the entity and its workers are located, the size of the entity, the type of data accessed or shared, the location of where the data was accessed or shared, the sensitivity of the data, etc. In addition, determining compliance and maturity of the entity's process controls with applicable laws, regulations or rules is a complex and formidable task.

An example of mapping multiple governance, risk and compliance (GRC) mandates against each other in order to identify “common controls” is provided by the United Compliance Framework (UCF). UCF maintains a database of mandate “authority documents”, mandate citations, common controls and a defined terms dictionary. The UCF allows a user to input mandates of interest and to map the mandates on a one to one, one to many and many to many basis in order to produce a hierarchical list of common controls among the selected mandates. These common controls are linked to roles, assets, records, activities, events and audit questions. This list and related reports help UCF users identify overlaps among mandates, identify and remedy gaps in the user organization's GRC program and support a compliance audit program.

### SUMMARY

The illustrative embodiments of the present invention provide a system, method and computer program product for assessing risk of a process through a set of entities identified as utilizing personal data needing protection from misuse and wrongful disclosure comprising mapping the identified process including identifying a purpose of the identified process and a sensitivity of that purpose; identifying data elements including the utilized personal data and including a volume and sensitivity of those identified data elements; identifying data types including the utilized personal data and including a volume and sensitivity of those identified data types; identifying data subjects about whom data is involved in the process including a volume and sensitivity of those identified data subjects; and identifying the set of entities involved in the process and their locations; and identifying data flows among the set of entities involved in the process; and applying a set of rules against the mapped process to provide a risk assessment of the mapped process based on the risk sensitivity of the process purpose, sensitivity and volume of each data element, data type, and data subject, risk related to the entity locations and data flows among the entity locations.

### BRIEF DESCRIPTION OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 provides a block diagram of an illustrative data processing system in which various embodiments of the present disclosure may be implemented;

FIG. 2 provides a block diagram of an illustrative network of data processing systems in which various embodiments of the present disclosure may be implemented;

FIG. 3 provides a high-level block diagram of a data flow manager and a risk assessment manager in which various embodiments of the present disclosure may be implemented;

FIG. 4 provides a flow diagram of the operation of the data flow manager and risk assessment manager in identifying and assessing the risks of processes involving personal data, including sensitive data, in which various embodiments of the present disclosure may be implemented; and

FIGS. 5A-5C provide display screens and other outputs utilized by users to document an identified process and to assess the risks of that identified process in which various embodiments of the present disclosure may be implemented.

### DETAILED DESCRIPTION

Processes and devices may be implemented and utilized for a risk assessment of processes involving personal data, including sensitive data. These processes and apparatuses may be implemented and utilized as will be explained with reference to the various embodiments below.

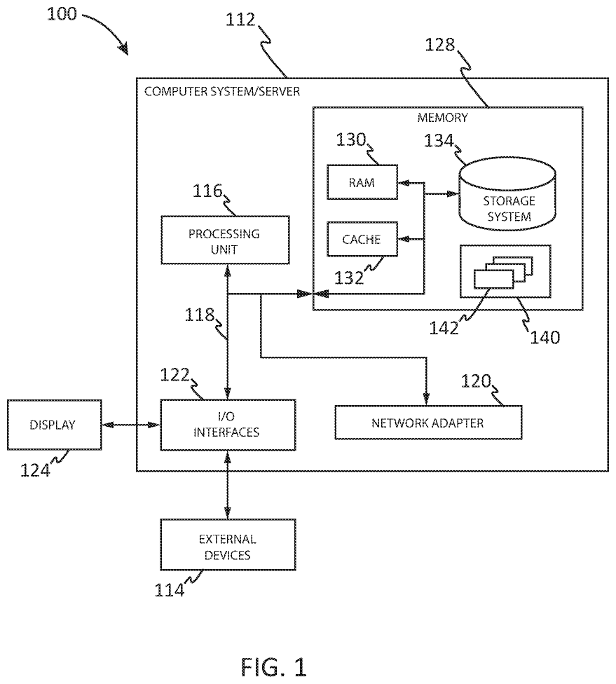

FIG. 1 provides a block diagram of an illustrative data processing system in which various embodiments of the present disclosure may be implemented. Data processing system 100 is one example of a suitable data processing system and is not intended to suggest any limitation as to the scope of use or functionality of the embodiments described herein. Regardless, data processing system 100 is capable of being implemented and/or performing any of the functionality set forth herein such as risk assessment of processes involving personal data, including sensitive data.

In data processing system 100 there is a computer system/server 112, which is operational with numerous other general purpose or special purpose computing system environments, peripherals, or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 112 may be described in the general context of computer system-performable instructions, such as program modules, being processed by a computer system. Generally, program modules may include routines, programs, objects, components, logic, data structures, and so on that perform particular tasks or implement particular abstract data types. Computer system/server 112 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 112 in data processing system 100 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of non-transitory computer system usable media. Such media may be any available media that is accessible by computer system/server 112, and it includes both volatile and non-volatile media, removable and non-removable media.

System memory 128 can include non-transitory computer system readable media in the form of volatile memory, such as random-access memory (RAM) 130 and/or cache memory 132. Computer system/server 112 may further include other non-transitory removable/non-removable, volatile/non-volatile computer system storage media. By way of example, storage system 134 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 118 by one or more data media interfaces. Memory 128 may include at least one program product having a set (e.g., at least one) of program modules that are configured to carry out the functions of the embodiments. Memory 128 may also include data that will be processed by a program product.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of the embodiments. For example, a program module may be software for risk assessment of processes involving sensitive data.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interfaces 122 through wired connections or wireless connections. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples, include, but are not limited to: microcode, device drivers, tape drives, RAID systems, redundant processing units, data archival storage systems, external disk drive arrays, etc.

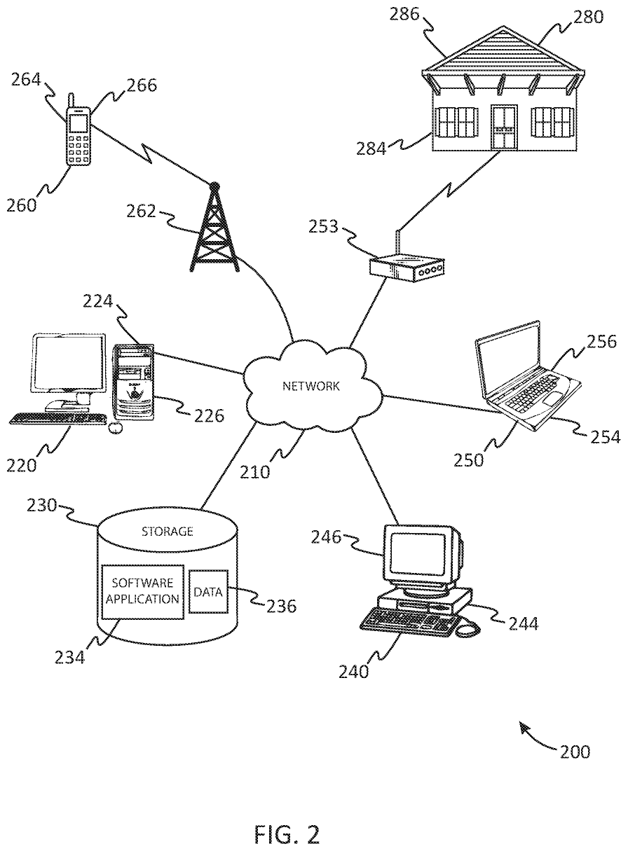

FIG. 2 provides a block diagram of an illustrative network of data processing systems in which various embodiments of the present disclosure may be implemented. Data processing environment 200 is a network of data processing systems such as described above with reference to FIG. 1. Software applications such as for risk assessment of processes involving personal data, including sensitive data, may be processed on any computer or other type of data processing system in data processing environment 200. Data processing environment 200 includes network 210. Network 210 is the medium used to provide simplex, half duplex and/or full duplex communications links between various devices and computers connected together within data processing environment 200. Network 210 may include connections such as wire, wireless communication links, or fiber optic cables.

Server 220 and client 240 are coupled to network 210 along with storage unit 230. In addition, laptop 250 and facility 280 (such as a home or business) are coupled to network 210 including wirelessly such as through a network router 253. A mobile device 260 such as a mobile phone may be coupled to network 210 through a cell tower 262. Data processing systems, such as server 220, client 240, laptop 250, mobile device 260 and facility 280 contain data and have software applications including software tools processing thereon. Other types of data processing systems such as personal digital assistants (PDAs), smartphones, tablets and netbooks may be coupled to network 210.

Server 220 may include software application 224 and data 226 for risk assessment of processes involving personal data, including sensitive data or other software applications and data in accordance with embodiments described herein. Storage 230 may contain software application 234 and a content source such as data 236 for risk assessment of processes involving personal data, including sensitive data. Other software and content may be stored on storage 230 for sharing among various computer or other data processing devices. Client 240 may include software application 244 and data 246. Laptop 250 and mobile device 260 may also include software applications 254 and 264 and data 256 and 266. Facility 280 may include software applications 284 and data 286 on local data processing equipment. Other types of data processing systems coupled to network 210 may also include software applications. Software applications could include a web browser, email, or other software application for risk assessment of processes involving sensitive data.

Server 220, storage unit 230, client 240, laptop 250, mobile device 260, and facility 280 and other data processing devices may couple to network 210 using wired connections, wireless communication protocols, or other suitable data connectivity. Client 240 may be, for example, a personal computer or a network computer.

In the depicted example, server 220 may provide data, such as boot files, operating system images, and applications to client 240 and laptop 250. Server 220 may be a single computer system or a set of multiple computer systems working together to provide services in a client server environment. Client 240 and laptop 250 may be clients to server 220 in this example. Client 240, laptop 250, mobile device 260 and facility 280 or some combination thereof, may include their own data, boot files, operating system images, and applications. Data processing environment 200 may include additional servers, clients, and other devices that are not shown.

In the depicted example, data processing environment 200 may be the Internet. Network 210 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 200 also may be implemented as a number of different types of networks, such as for example, an intranet, a local area network (LAN), or a wide area network (WAN). FIG. 2 is intended as an example, and not as an architectural limitation for the different illustrative embodiments.

Among other uses, data processing environment 200 may be used for implementing a client server environment in which the embodiments may be implemented. A client-server environment enables software applications and data to be distributed across a network such that an application functions by using the interactivity between a client data processing system and a server data processing system. Data processing environment 200 may also employ a service-oriented architecture where interoperable software components distributed across a network may be packaged together as coherent business applications.

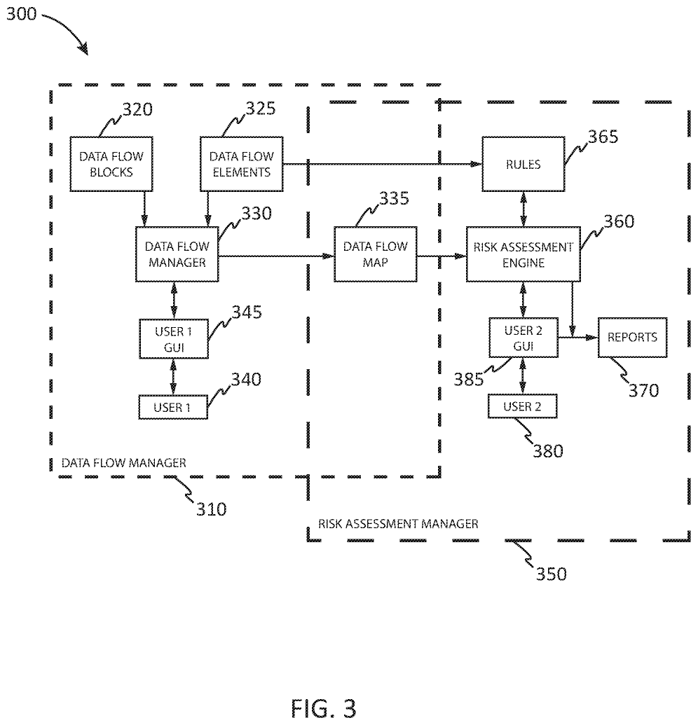

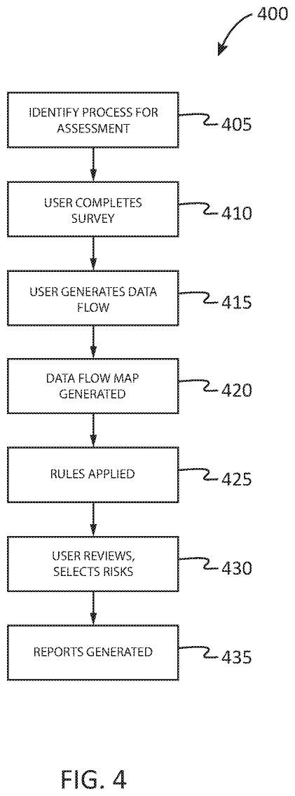

FIG. 3 provides a high-level block diagram 300 of a data flow manager 310 and a risk assessment manager 350 in which various embodiments of the present disclosure may be implemented. Data flow manager 310 can be utilized for documenting various business processes that may involve personal data, including sensitive data, as data flow maps. Risk assessment manager 350 can be utilized for a risk assessment of these data flow maps and a set of entities that may be involved in the data flow such as may be required by various laws, regulations or rules addressing and enforcing certain data management policies (e.g., the EU GDPR). A high-level flow diagram of the operation of the data flow manager and the risk assessment manager is provided below with reference to FIG. 4.

Data flow manager 310 includes a set of data flow blocks 320 and data flow elements 325 utilized by a data flow manager 330 to generate data flow map 335 pursuant to the instructions of a user 1 340 through a user 1 graphical user interface (GUI) 345. Data flow map 335 is then utilized by risk assessment engine 360 utilizing rules 365 to generate a risk assessment including reports 370 pursuant to the instructions of user 2 380 through user 2 GUI 385. Rules 365 may also obtain or receive the sensitivity of certain data elements from data flow elements 325 pursuant to the operation of risk assessment engine 360. User 2 380 and User 1 340 may be the same user or may be different users. In addition, multiple users may perform the role of either User 1 or User 2. Further details of the utilization of data flow manager 310 and risk assessment manager 350 are described below with reference to FIG. 4.

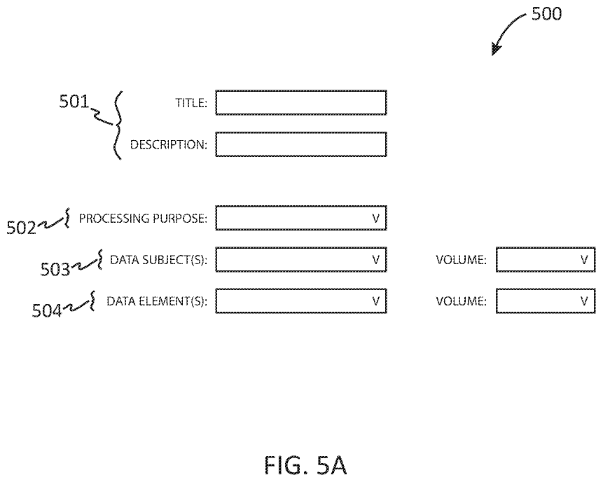

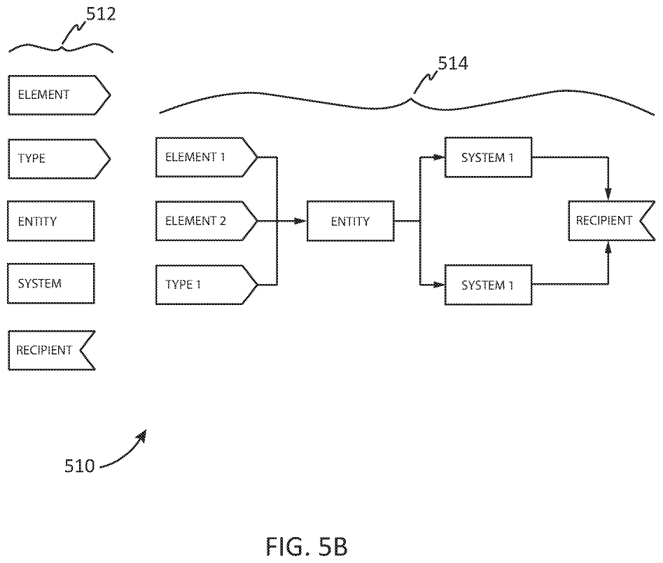

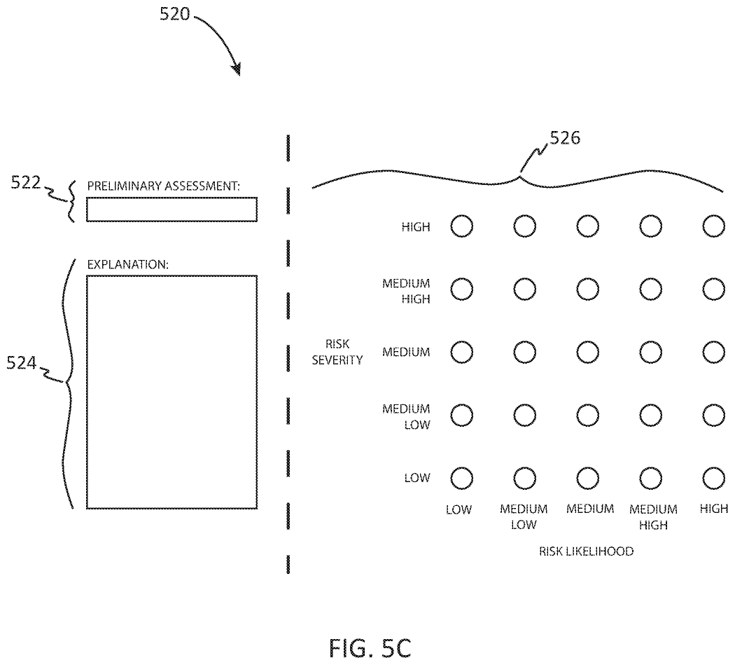

FIG. 4 provides a flow diagram 400 of the operation of the data flow manager and risk assessment manager in identifying and assessing risks of processes involving personal data, including sensitive data, in which various embodiments of the present disclosure may be implemented. Although the below description references multiple users (e.g., user 1 and user 2), a single user may perform the various steps of this flow diagram. The description below includes references to elements shown in FIG. 3. The description below also references various GUI screens and outputs as shown in FIGS. 5A-5C.

In a first step 405, a user, such as a person or entity, may identify a business-related process which may involve personal data, including sensitive data and which may be subject to various laws, regulations or rules addressing and enforcing certain data management policies (e.g., the EU GDPR). Factors used to make this identification include the location of the source, use or storage of personal data, the location of the entity and its operations and employees, and other factors which may affect the applicability of various laws and regulations. This identified business-related process may be an automated information technology system which captures and utilizes personal data pursuant to the sales, financial, manufacturing, on-line systems or other operations of an entity.

Then in steps 410 through 420, pursuant to the identification of the business process in step 405, user 1 utilizes user 1 GUI to document that identified business process as a data flow map 335 utilizing data flow manager 330. In step 410, user 1 provides certain general information about the identified process through a survey 500 provided by User 1 GUI such as shown in FIG. 5A. User 1 can enter general information of the identified process such as a title and description 501. User 1 can also select a processing purpose 502 through the use of pull-down menus derived from data flow elements 325. Each of the processing purposes provided can have an inherent sensitivity associated with specific risk factors based on potential adverse impacts that are applied to data flow elements 325. This sensitivity can be predetermined and stored in data flow elements 325. For example, highly sensitive processing purposes can include customer profiling, health assessments, etc. User 1 can also select one or more data subjects and a volume for each data subject 503 through the use of a pull-down menu derived from data flow elements 325. Alternatively, a list of possible data subjects and associated volumes can be provided for selection through the use of radio buttons or other types of GUI selections. The volume of data subjects involved is typically expressed as various ranges such as from 0-100, 100-10000, etc., also derived from data flow elements 325. Each of data subject selections provided and volumes thereof can have an inherent sensitivity associated with them based on potential adverse impacts that are applied to data flow elements 325. This sensitivity can be predetermined, provided by the user, or recommended but modifiable by the user, and stored in data flow elements 325. For example, highly sensitive data subject selections can include biometric data relating to data subjects, etc. and highly sensitive data subject volumes could be biometric data related to 1000 different individuals (data subjects). User 1 can also select from a variety of data elements and volumes 504 that are processed or otherwise handled by the identified business process through the use of pull-down menus derived from data flow elements 325. Alternatively, a list of possible data elements and associated volumes can be provided for selection through the use of radio buttons or other types of GUI selections. The volume of data elements involved is typically expressed as various ranges such as from 0-100, 100-1000, etc., also derived from data flow elements 325. Each of data element selections provided and volumes thereof can have a sensitivity associated with them such as high, medium high, medium, medium low or low sensitivity in data flow elements 325. This sensitivity can be predetermined, provided by the user, or recommended but modifiable by the user. For example, highly sensitive data element selections can include passport numbers, credit card numbers, etc. and highly sensitive data element volumes could be 1000 or more passport numbers or 1000 or more credit card numbers. Other information could be collected in this step including entities, systems and recipients of data elements and data types.

In step 415, the user through a data flow manager can automatically generate a data flow 514 through the user's selection of originating and recipient data flow blocks, such as through a drag and drop process, showing the flow of the selected data elements and data subject types from step 410 through various entities and systems to recipients. The automatically generated data flow can be visualized as a series of connected data flow blocks or as a set of flows on a global map. An example of this is shown in FIG. 5B. On the left of FIG. 5B, various data elements, data types, entities, systems and recipients 512 are provided as boxes for selection by user 1 340 through user 1 GUI 345. The data elements and data types may be provided based on user selections as described above in step 410. Entities, systems and recipients could also have been selected by the user in step 410 above and provided in selection 512. Alternatively, user 1 could select a generic box from box selection 512 and then label it as a specific data element, data type, entity, system or recipient. The user then selects a box from box selection 512 and drags it to an appropriate location in data flow 514. Where the selected box is dropped can be utilized to generate a pointer from a previous box to the currently dropped box, assuming all data flow is from left to right. Alternatively, the user can also draw a pointer utilizing a touch screen or mouse. If a generic box has been selected, then the user can provide a label for that box. More than one data flow can be generated to describe a process flow. This process continues until the user has completed the process of defining the process flow. In step 420, once user 1 has indicated that the data flow mapping has been completed including the survey and the data flow, data flow manager automatically generates a data flow that can be visualized as a series of connected data flow blocks or as a set of flows on a global map. The data flow map is compiled and provided to risk assessment engine 360 for assessment. This data flow map includes the results of the user inputs to the data flow generation process.

In step 425, risk assessment engine 360 applies a set of rules against the process described in data flow map 335 including sensitivities obtained from data flow elements 325 to generate a preliminary risk assessment. For example, if there are multiple data elements with low volumes that are highly sensitive or one data element with high volume that is highly sensitive, the business process described in data flow map 335 may be preliminarily determined by rules 365 to present a high severity of risk that improper use or disclosure of the personal data could result in injury to the rights and freedoms of the involved data subject. Alternatively, if there are few data elements or data element types with high sensitivity and low volumes, data flow map may be preliminarily determined by rules 365 to have a low or medium severity of risk. This determination is preliminary and subject to modification by the user (e.g. user 2 380). The user can also select a risk likelihood as described below.

In step 430, this preliminary risk assessment 522 is provided to the user in an on-line report (e.g., user 2 380 through user 2 GUI 385) as shown in FIG. 5C including the rules used to make that preliminary determination. Additional background information 524 such as why the rule makes this preliminary determination (e.g., statutory or regulatory requirements, comparable experience with other similar entities, etc.). Also provided to the user is a selection grid 526 of radio buttons so the user can select the appropriate risk severity and likelihood of the risk occurring based on the preliminary risk assessment and experience of the user. Alternative methods of obtaining user selection such as a pair of sliding scales can also be utilized. Based on the user selection, further documentation and assessment of the identified process, including mitigating controls and safeguards may be needed, such as through a Data Protection Impact Assessment (DPIA).

The user, in step 435, can then request that certain reports 370 be generated. This can include an audit report showing how the results were reached, the initiation of a data protection impact assessment (DPIA), or a similar for of impact assessment or risk assessment (each of which may be referred to herein as an impact/risk assessment) with calculations derived from the risk assessment values with appropriate portions filled in based on the results of the above described process, an executive summary of the results, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction processing device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may be processed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may process the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which are processed via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which are processed on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more performable instructions for implementing the specified logical function(s). In some alternative implementations, the functions noted in the blocks may occur out of the order noted in the Figures. For example, two blocks shown in succession may, in fact, be processed substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A data processing system suitable for storing and/or processing program code will include at least one processor coupled directly or indirectly to memory elements through a system bus. The memory elements can include local memory employed during actual processing of the program code, bulk storage media, and cache memories, which provide temporary storage of at least some program code in order to reduce the number of times code must be retrieved from bulk storage media during processing.

A data processing system may act as a server data processing system or a client data processing system. Server and client data processing systems may include data storage media that are computer usable, such as being computer readable. A data storage medium associated with a server data processing system may contain computer usable code such as for risk assessment of processes involving sensitive data. A client data processing system may download that computer usable code, such as for storing on a data storage medium associated with the client data processing system, or for using in the client data processing system. The server data processing system may similarly upload computer usable code from the client data processing system such as a content source. The computer-usable code resulting from a computer-usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A data processing system for assessing risk of a process through a set of entities identified as utilizing personal data needing protection from misuse and wrongful disclosure, the data processing system comprising:
a processor; and
a memory storing program instructions which when processed by the processor perform the steps of:
mapping the identified process including:
identifying a purpose of the identified process and a sensitivity of that purpose;
identifying data elements including the utilized personal data and including a volume and sensitivity of those identified data elements;
identifying data types including the utilized personal data and including a volume and sensitivity of those identified data types;
identifying data subjects about whom data is involved in the process including a volume and sensitivity of those identified data subjects; and
identifying the set of entities involved in the process and their locations; and
identifying data flows among the set of entities involved in the process; and
applying a set of rules against the mapped process to provide a risk assessment of the mapped process based on the risk sensitivity of the process purpose, sensitivity and volume of each data element, data type, and data subject, risk related to the entity locations and data flows among the entity locations.

2. The data processing system of claim 1 further comprising generating a report, utilizing the risk assessment of the mapped process through the set of entities, suitable for use as part of a data protection impact assessment.

3. The data processing system of claim 1 wherein the personal data includes sensitive data subject to legally enforceable data management policies.

4. The data processing system of claim 3 wherein the identified process includes business related processes in an automated information technology system for an entity.

5. The data processing system of claim 4 wherein applying the rules against the mapped process includes determining a preliminary severity of risk.

6. The data processing system of claim 5 further comprising:
providing a selection tool to a user for selecting an inherent risk level of severity and likelihood based on the preliminary severity of risk; and
responsive to the user selecting the risk severity and likelihood of risk, providing an audit report including the risk assessment of the mapped process and initiating a document for addressing the data management policies.

7. A computer program product for assessing risk of a process through a set of entities identified as utilizing personal data needing protection from misuse and wrongful disclosure, the computer program product comprising a non-transitory computer readable storage medium having program instructions embodied therewith, the program instructions processed by a processing circuit to cause the device to perform a method comprising:
mapping the identified process including:
identifying a purpose of the identified process and a sensitivity of that purpose;
identifying data elements including the utilized personal data and including a volume and sensitivity of those identified data elements;
identifying data types including the utilized personal data and including a volume and sensitivity of those identified data types;
identifying data subjects about whom data is involved in the process including a volume and sensitivity of those identified data subjects; and
identifying the set of entities involved in the process and their locations; and
identifying data flows among the set of entities involved in the process; and
applying a set of rules against the mapped process to provide a risk assessment of the mapped process based on the risk sensitivity of the process purpose, sensitivity and volume of each data element, data type, and data subject, risk related to the entity locations and data flows among the entity locations.

8. The computer program product of claim 7 further comprising generating a report, utilizing the risk assessment of the mapped process through the set of entities, suitable for use as part of an impact/risk assessment.

9. The computer program product of claim 7 wherein the personal data includes sensitive data subject to legally enforceable data management policies.

10. The computer program product of claim 9 wherein the identified process includes business related processes in an automated information technology system for an entity.

11. The computer program product of claim 10 wherein applying the rules against the mapped process includes determining a preliminary severity of risk.

12. The computer program product of claim 11 further comprising:
providing a selection tool to a user for selecting an inherent risk level of severity and likelihood based on the preliminary severity of risk; and
responsive to the user selecting the risk severity and likelihood of risk, providing an audit report including the risk assessment of the mapped process and initiating a document for addressing the data management policies.

13. The computer program product of claim 7 wherein the set of rules represent standards from multiple jurisdictions potentially applicable to an entity for protecting the personal data.

14. A method of assessing risk of an information technology implemented process through a set of entities identified as utilizing personal data needing protection from misuse and wrongful disclosure comprising:
mapping the identified process including:
identifying a purpose of the identified process and a sensitivity of that purpose;
identifying data elements including the utilized personal data and including a volume and sensitivity of those identified data elements;
identifying data types including the utilized personal data including a volume and sensitivity of those identified data types;
identifying data subjects about whom data is involved in the process including a volume and sensitivity of those identified data subjects; and
identifying the set of entities involved in the process and their locations; and
identifying data flows among the set of entities involved in the process; and
applying a set of rules against the mapped process to provide a risk assessment of the mapped process based on the risk sensitivity of the process purpose, sensitivity and volume of each data element, data type and data subject, risk related to the entity locations, and data flows among the entity locations.

15. The method of claim 14 further comprising generating a report, utilizing the risk assessment of the mapped process through the set of entities, suitable for use as part of a data protection impact assessment.

16. The method of claim 14 wherein the personal data includes sensitive data subject to legally enforceable data management policies.

17. The method of claim 16 wherein the identified process includes business related processes in an automated information technology system for an entity.

18. The method of claim 17 wherein applying the rules against the mapped process includes determining a preliminary severity of risk.

19. The method of claim 18 further comprising:
providing a selection tool to a user for adjusting the preliminary severity of risk and selecting a likelihood of risk; and
responsive to the user selecting the risk severity and likelihood of risk, providing an audit report including the risk assessment of the mapped process and initiating a document for addressing the data management policies.

20. The method of claim 14 wherein the set of rules represent standards from multiple jurisdictions potentially applicable to an entity for protecting the personal data.
